(19) United States
(12) Patent Application Publication
(10) Pub. No.: US 2023/0179382 A1
(43) Pub. Date: Jun. 8, 2023

(54) INTER-BASE STATION CROSS-LINK INTERFERENCE CHANNEL MEASUREMENTS

(71) Applicant: QUALCOMM Incorporated, San Diego, CA (US)

(72) Inventors: Abdelrahman Mohamed Ahmed Mohamed Ibrahim, San Diego, CA (US); Muhammad Sayed Khairy Abdelghaffar, San Jose, CA (US); Huilin Xu, Temecula, CA (US); Ahmed Attia Abotabl, San Diego, CA (US); Seyedkianoush Hosseini, San Diego, CA (US); Wanshi Chen, San Diego, CA (US)

(21) Appl. No.: 17/544,692

(22) Filed: Dec. 7, 2021

(51) Int. Cl. H04L 5/00; H04B 17/345; H04W 24/10

(52) U.S. Cl. CPC H04L 5/0073; H04L 5/0048; H04B 17/345; H04L 5/0032; H04W 24/10

(57) ABSTRACT

Methods, systems, and devices for wireless communications are described. In some wireless communications systems, a first base station may receive, from one or more aggressor base stations, a first set of reference signals associated with cross-link interference (CLI) channel measurements. The first base station may identify the second base station based on receiving a second set of reference signals from each aggressor base station from the set, where each aggressor base station transmits downlink signals that interfere with uplink signals at the first base station. The first base station may measure the first set of reference signals to obtain a CLI channel measurement and transmit a measurement report indicating the CLI channel measurements. In some examples, the first base station, the second base station, or both may perform one or more CLI mitigation procedures based on the CLI channel measurements.

### FIELD OF TECHNOLOGY

The following relates to wireless communications, including inter-base station cross-link interference (CLI) measurements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, wireless devices (e.g., UEs, base stations) may be affected by various types of interference from various sources. Techniques for measuring such interference may be improved.

### SUMMARY

The described techniques relate to improved methods, systems, devices, and apparatuses that support inter-base station cross-link interference (CLI) channel measurements. Generally, the described techniques provide for measuring a CLI channel between an aggressor base station and a victim base station to perform interference cancellation or mitigation procedures. In some examples, a victim base station may identify one or more dominant aggressor base stations in a wireless communications system, where a dominant aggressor base station may be an aggressor base station with interfering signals that satisfy an interference threshold at the victim base station. In some cases, the victim base station may identify the one or more dominant aggressor base stations based on a first set of references signals received from each of the one or more aggressor base stations, which may include remote interference management (RIM) reference signals. Upon identifying a dominant aggressor base station, the victim base station and the aggressor base station may exchange signaling that may configure various parameters for CLI channel measurements at the victim base station. In some examples, the victim base station, the dominant aggressor base station, or both may configure the CLI channel measurements and the dominant aggressor base station may transmit one or more reference signals from a second set of reference signals to the victim base station. The victim base station may perform CLI channel measurements using these reference signals from the dominant aggressor base station, and the CLI channel measurements may be reported to the dominant aggressor base station (e.g., via a backhaul link). The victim base station and the dominant aggressor base station may use the CLI channel measurements to perform interference mitigation, which may include beamforming nulling, digital interference cancellation, among other mitigation techniques.

A method for wireless communication at a first base station is described. The method may include receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station, measuring the first set of reference signals to obtain the CLI channel measurements, and performing one or more CLI mitigation procedures based on the CLI channel measurements.

An apparatus for wireless communication at a first base station is described. The apparatus may include a memory and a processor coupled to the memory and configured to cause the apparatus to receive, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station, measure the first set of reference signals to obtain the CLI channel measurements, and perform one or more CLI mitigation procedures based on the CLI channel measurements.

Another apparatus for wireless communication at a first base station is described. The apparatus may include means for receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station, means for measuring the first set of reference signals to obtain the CLI channel measurements, and means for performing one or more CLI mitigation procedures based on the CLI channel measurements.

A non-transitory computer-readable medium storing code for wireless communication at a first base station is described. The code may include instructions executable by a processor to receive, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station, measure the first set of reference signals to obtain the CLI channel measurements, and perform one or more CLI mitigation procedures based on the CLI channel measurements.

Some examples of the method, apparatuses, and non-transitory computer-readable medium described herein may further include operations, features, means, or instructions for transmitting, to each aggressor base station from the set of one or more aggressor base stations, one or more reference signals of the second set of reference signals based on an uplink signal of the first base station being affected by CLI and receiving, from each aggressor base station from the set of one or more aggressor base stations, one or more additional reference signals of the second set of reference signals in response to the transmitted one or more reference signals, where the second base station may be identified based on one or more additional reference signals received from the second base station satisfying a threshold interference level.

Some examples of the method, apparatuses, and non-transitory computer-readable medium described herein may further include operations, features, means, or instructions for receiving one or more reference signals of the second set of reference signals from the second base station, the one or more reference signals including an identifier of the second base station, where the second base station may be identified based on the identifier or the second base station and the one or more reference signals from the second base station satisfying a threshold interference level.

Some examples of the method, apparatuses, and non-transitory computer-readable medium described herein may further include operations, features, means, or instructions for determining one or more beam directions used by the second base station for transmitting the downlink signals based on a quasi co-location (QCL) relationship between the first set of reference signals and the second set of reference signals, where the one or more CLI mitigation procedures may be based on the one or more beam directions.

Some examples of the method, apparatuses, and non-transitory computer-readable medium described herein may further include operations, features, means, or instructions for receiving, from the second base station, a message indicating a configuration of the first set of reference signals, where the configuration of the first set of reference signals includes one or more types of reference signals used for the first set of reference signals, time and frequency resources associated with the first set of reference signals, port information associated with the first set of reference signals, or any combination thereof.

In some examples of the method, apparatuses, and non-transitory computer-readable medium described herein, the message indicating the configuration of the first set of reference signals may be received over a backhaul link between the first base station and the second base station.

Some examples of the method, apparatuses, and non-transitory computer-readable medium described herein may further include operations, features, means, or instructions for transmitting, to the second base station, a measurement report including an indication of the CLI channel measurements.

In some examples of the method, apparatuses, and non-transitory computer-readable medium described herein, indication of the CLI channel measurements includes an explicit indication of the CLI channel measurements, the explicit indication being compressed or uncompressed.

In some examples of the method, apparatuses, and non-transitory computer-readable medium described herein, the indication of the CLI channel measurements includes one or more channel statistics, one or more CLI metrics, a received signal strength indicator (RSSI), a reference signal received power (RSRP), or any combination thereof.

In some examples of the method, apparatuses, and non-transitory computer-readable medium described herein, the measurement report may be transmitted over a backhaul link between the first base station and the second base station.

In some examples of the method, apparatuses, and non-transitory computer-readable medium described herein, measuring the first set of reference signals may include operations, features, means, or instructions for selecting one or more combiner matrices based on a combiner codebook that includes a set of two or more combiner matrices, measuring, in a first subband, one or more reference signals of the first set of reference signals using the one or more combiner matrices, and measuring, in a second subband, one or more additional reference signals of the first set of reference signals using the one or more combiner matrices.

Some examples of the method, apparatuses, and non-transitory computer-readable medium described herein may further include operations, features, means, or instructions for selecting, for each of the first subband and the second subband, a respective combiner matrix from the one or more combiner matrices that may be associated with a threshold level of CLI based on measuring the one or more reference signals and the one or more additional reference signals.

Some examples of the method, apparatuses, and non-transitory computer-readable medium described herein may further include operations, features, means, or instructions for communicating signaling with the second base station that indicates a resource allocation, or one or more directional beams, or both, used by the first base station and the second base station for periodic transmissions to one or more other devices, where the resource allocation, or the one or more directional beams, or both, may be configured to mitigate CLI at the first base station based on the signaling.

In some examples of the method, apparatuses, and non-transitory computer-readable medium described herein, the signaling includes an indication of one or more patterns corresponding to the periodic transmissions, and where mitigation of the CLI may be based on the one or more patterns.

In some examples of the method, apparatuses, and non-transitory computer-readable medium described herein, measuring the first set of reference signals may include operations, features, means, or instructions for measuring respective reference signals received in each subband of a set of subbands to obtain the CLI channel measurements.

In some examples of the method, apparatuses, and non-transitory computer-readable medium described herein, the set of subbands may be configured for full-duplex communications.

In some examples of the method, apparatuses, and non-transitory computer-readable medium described herein, the one or more CLI mitigation procedures include beamforming nulling, combiner modification, interference cancellation, or any combination thereof.

In some examples of the method, apparatuses, and non-transitory computer-readable medium described herein, the first set of reference signals include one or more types of reference signals, the one or more types of reference signals including a channel state information (CSI) reference signal (CSI-RS), a synchronization signal block (SSB), a demodulation reference signal (DMRS), or any combination thereof.

In some examples of the method, apparatuses, and non-transitory computer-readable medium described herein, measuring the first set of reference signals may include operations, features, means, or instructions for measuring the first set of reference signals using a single-port measurement scheme or a multi-port measurement scheme, or both, based on the one or more types of reference signals.

A method for wireless communication at a first base station is described. The method may include transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station, receiving, from the second base station, a measurement report including an indication of CLI channel measurements that are based on the first set of reference signals, and performing one or more CLI management procedures based on the CLI channel measurements.

An apparatus for wireless communication at a first base station is described. The apparatus may include a memory and a processor coupled to the memory and configured to cause the apparatus to transmit, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station, receive, from the second base station, a measurement report including an indication of CLI channel measurements that are based on the first set of reference signals, and perform one or more CLI management procedures based on the CLI channel measurements.

Another apparatus for wireless communication at a first base station is described. The apparatus may include means for transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station, means for receiving, from the second base station, a measurement report including an indication of CLI channel measurements that are based on the first set of reference signals, and means for performing one or more CLI management procedures based on the CLI channel measurements.

A non-transitory computer-readable medium storing code for wireless communication at a first base station is described. The code may include instructions executable by a processor to transmit, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station, receive, from the second base station, a measurement report including an indication of CLI channel measurements that are based on the first set of reference signals, and perform one or more CLI management procedures based on the CLI channel measurements.

Some examples of the method, apparatuses, and non-transitory computer-readable medium described herein may further include operations, features, means, or instructions for receiving, from the second base station, one or more reference signals of the second set of reference signals based on an uplink signal of the first base station being affected by CLI from downlink signals from the first base station and transmitting, to the second base station, one or more additional reference signals of the second set of reference signals in response to the received one or more reference signals, where the measurement report may be received based on one or more additional reference signals transmitted to the second base station satisfying a threshold interference level.

Some examples of the method, apparatuses, and non-transitory computer-readable medium described herein may further include operations, features, means, or instructions for transmitting, to the second base station, one or more reference signals of the second set of reference signals, the one or more reference signals including an identifier of the first base station, where the measurement report may be received based on the identifier or the first base station and the one or more reference signals transmitted to the second base station satisfying a threshold interference level.

Some examples of the method, apparatuses, and non-transitory computer-readable medium described herein may further include operations, features, means, or instructions for transmitting, to the second base station, a message indicating a configuration of the first set of reference signals, where the configuration of the first set of reference signals includes one or more types of reference signals used for the first set of reference signals, time and frequency resources associated with the first set of reference signals, port information associated with the first set of reference signals, or any combination thereof.

In some examples of the method, apparatuses, and non-transitory computer-readable medium described herein, the message indicating the configuration of the first set of reference signals may be received over a backhaul link between the first base station and the second base station.

In some examples of the method, apparatuses, and non-transitory computer-readable medium described herein, the indication of the CLI channel measurements includes one or more channel statistics, one or more CLI metrics, an RSSI, an RSRP, or any combination thereof.

Some examples of the method, apparatuses, and non-transitory computer-readable medium described herein may further include operations, features, means, or instructions for communicating signaling with the second base station that indicates a resource allocation, or one or more directional beams, or both, used by the first base station and the second base station for periodic transmissions to one or more other devices, where the resource allocation, or the one or more directional beams, or both, may be configured to mitigate CLI at the first base station based on the signaling.

In some examples of the method, apparatuses, and non-transitory computer-readable medium described herein, the measurement report may be received over a backhaul link between the first base station and the second base station.

In some examples of the method, apparatuses, and non-transitory computer-readable medium described herein, the one or more CLI management procedures include beamforming modification, precoder modification, directional beam restriction, or any combination thereof.

### BRIEF DESCRIPTION OF THE DRAWINGS

FIG. 1 illustrates an example of a wireless communications system that supports inter-base station cross-link interference (CLI) channel measurements in accordance with aspects of the present disclosure.

FIG. 2 illustrates an example of a wireless communications system that supports inter-base station CLI channel measurements in accordance with aspects of the present disclosure.

FIG. 3 illustrates an example of a resource allocation that supports inter-base station CLI channel measurements in accordance with aspects of the present disclosure.

FIG. 4 illustrates an example of a process flow in a system that supports inter-base station CLI channel measurements in accordance with aspects of the present disclosure.

FIGS. 5 and 6 show block diagrams of devices that support inter-base station CLI channel measurements in accordance with aspects of the present disclosure.

FIG. 7 shows a block diagram of a communications manager that supports inter-base station CLI channel measurements in accordance with aspects of the present disclosure.

FIG. 8 shows a diagram of a system including a device that supports inter-base station CLI channel measurements in accordance with aspects of the present disclosure.

FIGS. 9 through 14 show flowcharts illustrating methods that support inter-base station CLI channel measurements in accordance with aspects of the present disclosure.

### DETAILED DESCRIPTION

Some wireless communications systems may by impacted by various types of interference from various sources. For example, a user equipment (UE) may receive a downlink signal from a serving base station in addition to one or more interfering signals from another UE, another base station, or both. In some cases, a base station may receive uplink transmissions which may be impacted by interference from downlink transmissions transmitted by another base station. For example, in wireless communication systems that support full-duplex communications, a base station may simultaneously transmit on the downlink and receive on the uplink. In some examples, two or more base stations may experience cross-link interference (CLI) (e.g., inter-base station interference), which may occur when a first base station is transmitting at the same time a second base station is receiving. A base station that transmits interfering downlink signals that cause CLI may be referred to as an aggressor base station (e.g., an aggressor gNodeB (gNB)), and a base station that is impacted by the CLI may be referred to as a victim base station (e.g., a victim gNB).

To mitigate CLI, an aggressor base station and a victim base station may communicate signaling to coordinate communications from each base station, for example, to ensure synchronous operations, coordinated operations, or any combination thereof. In some cases, the aggressor base station and the victim base station may determine to use coordinated directional beams that may avoid CLI, or an aggressor base station may modify resources used for its downlink transmissions to minimize CLI, among other examples. Techniques that support such coordination between base stations, however, may result in relatively increased signaling overhead.

Techniques described herein support measuring a CLI channel between an aggressor base station and a victim base station to perform interference cancellation procedures. In some examples, a victim base station may identify one or more dominant aggressor base stations in a wireless communications system, where a dominant aggressor base station may be an aggressor base station with interfering signals that satisfy an interference threshold at the victim base station. In some cases, the victim base station may identify the one or more dominant aggressor base stations based on a first set of references signals received from each of the one or more aggressor base stations. For instance, once the victim base station becomes aware of the CLI, the victim base station may transmit reference signals (e.g., including an identifier of the victim base station) from the first set of reference signals to an aggressor base station. In response, the aggressor base station may transmit reference signals from the first set of reference signals to the victim base station. The victim base station may identify the first base station as a dominant aggressor base station based on interference measurements of the reference signals satisfying a threshold. In other examples, the first aggressor base station may transmit the reference signals from the first set of reference signals, which may include an identifier of the aggressor base station. Based on the identifier and interference measurements satisfying a threshold, the victim base station may identify the aggressor base station as the dominant aggressor base station. In some examples, the first set of reference signals used to identify the aggressor and victim base station may include remote interference management (RIM) reference signals or other reference signals.

Upon identifying a dominant aggressor base station, the victim base station and the aggressor base station may exchange signaling that may configure various parameters for CLI channel measurements at the victim base station. In some examples, the victim and/or the aggressor base station may configure the CLI channel measurements (e.g., configure a type of reference signal, time and/or frequency locations of the reference signals, ports used for transmitting the reference signals, or the like), and the dominant aggressor base station may transmit one or more reference signals from a second set of reference signals to the victim base station based on the configuration. The victim base station may perform CLI channel measurements using these reference signals, where the CLI channel measurements may be transmitted to the aggressor base station (e.g., via a backhaul link). The victim base station and the dominant aggressor base station may use the CLI channel measurements to perform interference mitigation, which may include beamforming nulling, digital interference cancellation, among other mitigation techniques.

In some cases, the CLI channel measurements may enable the victim base station to identify the directions of beams used by the aggressor base station (e.g., based on a quasi co-location (QCL) relationship between reference signals from the first and second sets of reference signals). Additionally or alternatively, the victim base station and the dominant aggressor base station may use a combiner codebook for performing the CLI channel measurements, where the combiner codebook may include respective combiners (e.g., combiner matrices) used across different CLI channel measurements. In some cases, the victim base station may select a particular combiner (e.g., a subband-based combiner), which may enable the victim base station to more efficiently mitigate CLI from the one or more aggressor base stations. A combiner codebook may correspond to a precoding codebook (e.g., a precoding matrix codebook) used for beamforming, where the combiner codebook may be used at a receiving device, for example, when decoding one or more beamformed signals.

Aspects of the disclosure are initially described in the context of wireless communications systems. Aspects of the disclosure are then described in the context of resource allocations and process flows. Aspects of the disclosure are further illustrated by and described with reference to apparatus diagrams, system diagrams, and flowcharts that relate to inter-base station CLI channel measurements.

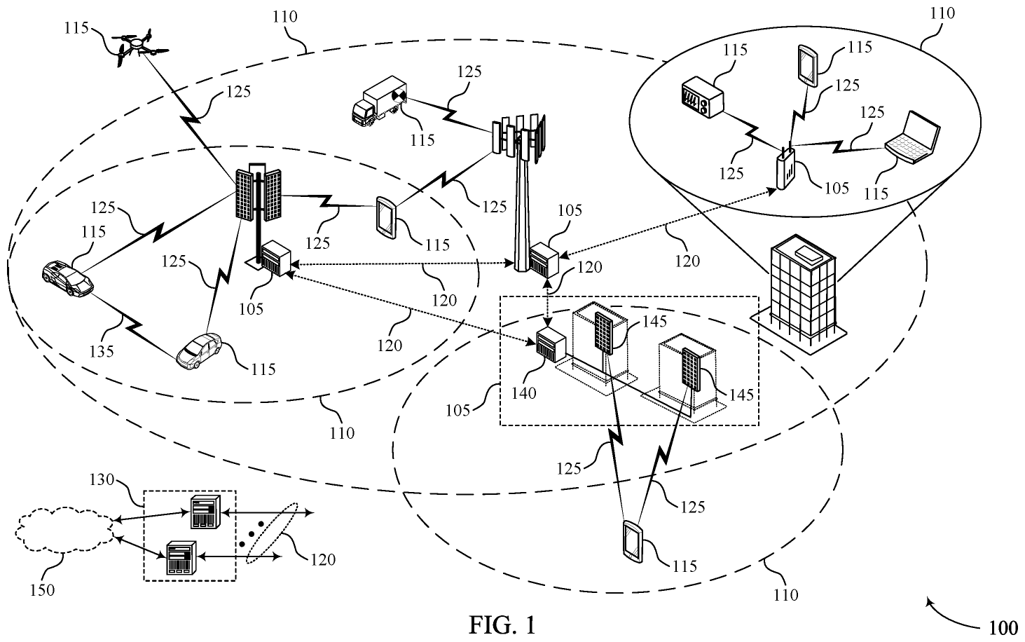

FIG. 1 illustrates an example of a wireless communications system 100 that supports inter-base station CLI channel measurements in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A QCL relationship between one or more transmissions or signals may refer to a relationship between the antenna ports (and the corresponding signaling beams) of the respective transmissions. For example, one or more antenna ports may be implemented by a base station 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted on a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relation between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relation between two or more directional beams used to communicate signals. Here, the spatial parameters indicate that a first beam used to transmit a first signal may be similar (or the same) as another beam used to transmit a second, different signal, or that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large number of beams to identify the best beam (e.g., the beam having a relatively highest signal quality)). In addition, QCL relationships may exist for both uplink and downlink transmissions and, in some cases, a QCL relationship may also be referred to as spatial relationship information.

In some examples, a transmission configuration indication (TCI) state configuration may include one or more parameters associated with a QCL relationship between transmitted signals. For example, a base station 105 may configure a QCL relationship that provides a mapping between a reference signal and antenna ports of another signal (e.g., a DMRS antenna port for PDCCH, a DMRS antenna port for PDSCH, a CSI-RS antenna port for CSI-RS, or the like), and the TCI state may be indicated to the UE 115 by the base station 105. In some cases, a set of TCI states may be indicated to a UE 115 via RRC signaling, where some number of TCI states (e.g., a pool of 8 TCI states from of a total of 64 TCI states may be configured via RRC) and a particular TCI state may be indicated via DCI (e.g., within a CORESET). The QCL relationship associated with the TCI state (and further established through higher-layer parameters) may provide the UE 115 with the QCL relationship for respective antenna ports and reference signals transmitted by the base station 105.

In some examples, wireless communications system 100 may by impacted by various types of interference from various sources. For example, a UE 115 may receive a downlink signal from a serving base station 105 in addition to one or more interfering signals from another UE 115, another base station 105, or both. In some cases, a base station 105 may receive uplink transmissions which may be impacted by interference from downlink transmissions transmitted by another base station 105. For example, in wireless communications systems 100 that support full-duplex communications, a base station 105 may simultaneously transmit on the downlink and receive on the uplink. The full-duplex communications may include in-band full-duplex (IBFD) where a base station 105 may transmit and receive on the same time and frequency resources and where the downlink and the uplink may share the same IBFD time and frequency resources (e.g., partially or fully overlapping). Additionally or alternatively, the full-duplex communications may include sub-band FDD (e.g., flexible duplex) where a base station 105 may transmit and receive at the same time but on different frequency resources, and where a downlink resource may be separated from an uplink resource in the frequency domain.

In some wireless communications systems 100 that support full-duplex communications, a base station 105 may operate using full-duplex communications and a UE 115 may operate using half-duplex communications. The base station 105 may have self-interference from downlink transmissions to uplink reception and interference from a different base station 105 (e.g., CLI), and the UE 115 may have interference from another UE 115. In some examples, the wireless communications system 100 may support a base station 105 and a UE 115 both using full-duplex communications, where the UE 115 may have self-interference from uplink transmission to downlink reception in addition to interference from another UE 115, a base station 105, or both. In some cases, the wireless communications system 100 may support a UE 115 using full-duplex communications and one or more transmit/receive points (TRPs), where the UE 115 may have self-interference from uplink transmission to downlink reception.

In some examples, two or more base stations 105 may experience CLI (e.g., inter-base station interference), which may occur when a first base station 105 (e.g., an aggressor base station 105) is transmitting interfering downlink signals at the same time a second base station 105 (e.g., a victim base station 105) is receiving uplink signals. For example, in full-duplex communications or in TDD scenarios, an aggressor base station 105 may transmit downlink communications to a first UE 115 and a victim base station 105 may receive uplink communications from a second UE 115. In some cases, the victim base station 105 may receive downlink to uplink interference from the aggressor base station 105 (e.g., intra-base station interference, inter-base station interference). The victim base station 105 may use spatial separation techniques, BWP partitioning (e.g., FDM), interference cancellation, or any combination thereof to mitigate intra-base station interference (e.g., co-channel interference). For example, the victim base station 105 may use the interference cancellation for intra-operator, inter-cell base station interference and clutter mitigation, which may include beamforming nulling at the transmitter and digital interference cancellation at the receiver. In some examples, the victim base station 105 may use a threshold (e.g., maximum) uplink and downlink BWP separation, co-located to spatial separation, or any combination thereof, to mitigate inter-base station interference (e.g., adjacent channel interference). Additionally or alternatively, the first UE 115 may be impacted by uplink to downlink interference from the second UE 115. The first UE 115 may use CLI-aided scheduling to mitigate intra-UE interference and a threshold (e.g., maximum) downlink and uplink BWP separation to mitigate inter-UE interference.

To mitigate CLI, an aggressor base station 105 and a victim base station 105 may communicate signaling to coordinate communications from each of the victim base station 105 and the aggressor base station 105, for example, to ensure synchronous operations, coordinated operations, or any combination thereof. In some cases, the aggressor base station 105 and the victim base station 105 may determine to use coordinated directional beams (e.g., coordination between neighboring cells and sectors) to reduce CLI (e.g., co-channel interference, dynamic TDD), which may include beam restriction, power back-off, dynamic zoning, slot conversion, or any combination thereof. Additionally or alternatively, the victim base station 105 may use beamforming nulling, interference cancellation, or any combination thereof, to mitigate CLI, in which case the channel between the victim base station 105 and the aggressor base station 105 (e.g., over an inter-base station channel) may project into null space. In some examples, the victim base station 105 may perform inter-base station channel measurements to mitigate CLI, where the victim base station 105 may mute uplink transmissions within CLI resources using an inter-base station channel and the aggressor base station 105 samples for interference cancellation.

In some examples, the victim base station 105 may minimize or reduce the impact of inter-base station CLI using coordination between schedulers of the victim base station 105 and the aggressor base station 105. For example, a common scheduler may be used for a multi-TRP system or a distributed antenna system (DAS). Additionally or alternatively, the victim base station 105 may use CLI mitigation techniques such as receive beamforming nulling, combiner optimization, digital interference cancellation, or any combination thereof, and the aggressor base station 105 may use CLI minimization techniques such as transmit beamforming, precoding optimization, beam restriction, or any combination thereof. However, for different base stations 105, coordinating a scheduling decision may use a relatively high signaling overhead, particularly for dynamically-scheduled channels.

Wireless communications system 100 may support techniques for measuring a CLI channel between an aggressor base station 105 and a victim base station 105 to perform interference cancellation procedures. In some examples, a victim base station 105 may identify one or more dominant aggressor base stations 105 in the wireless communications system 100, where a dominant aggressor base station 105 may be an aggressor base station 105 with interfering signals that satisfy an interference threshold at the victim base station 105. In some cases, the victim base station 105 may identify the one or more dominant aggressor base stations 105 based on a first set of references signals received from each of the one or more aggressor base stations 105, which may include RIM reference signals. Upon identifying a dominant aggressor base station 105, the victim base station and the aggressor base station 105 may exchange signaling that may configure various parameters for CLI channel measurements at the victim base station 105. The dominant aggressor base station 105 may transmit one or more reference signals from a second set of reference signals to the victim base station 105. The victim base station 105 may perform CLI channel measurements using these reference signals, and the CLI channel measurements may be transmitted to the dominant aggressor base station 105 (e.g., via a backhaul link 120). The victim base station 105 and the dominant aggressor base station 105 may use the CLI channel measurements to perform interference mitigation, which may include beamforming nulling, digital interference cancellation, among other mitigation techniques.

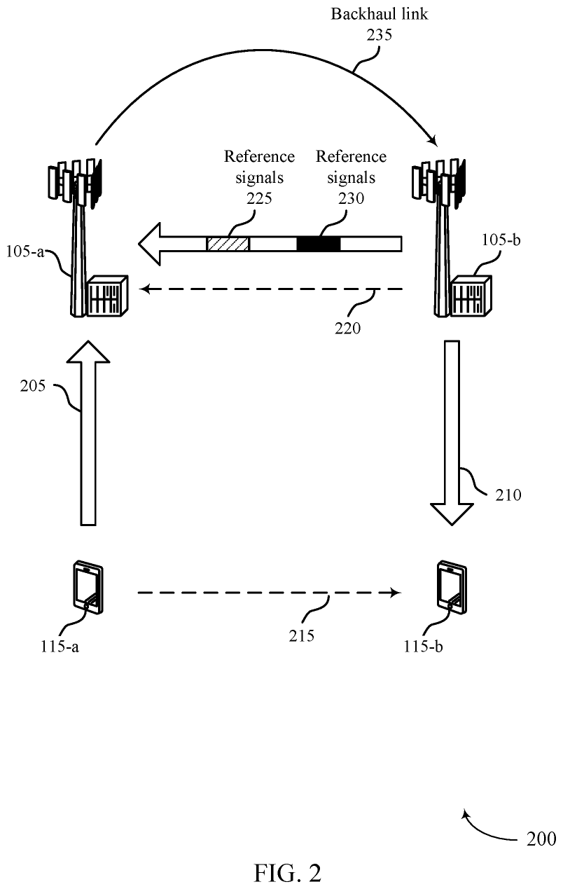

FIG. 2 illustrates an example of a wireless communications system 200 that supports inter-base station CLI channel measurements in accordance with aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, a base station 105-a, and a base station 105-b, which may be examples of corresponding devices described herein.

The base station 105-a (e.g., a victim base station) may receive messages on an uplink 205 from the UE 115-a, and the base station 105-b (e.g., an aggressor base station) may transmit messages on a downlink 210 to the UE 115-b). Some wireless devices (e.g., UEs 115, base stations 105) in the wireless communications system 200 may by impacted by various types of interference from various sources. For example, the UE 115-b may receive uplink-to-downlink interference 215 from the UE 115-a, and the base station 105-a may receive CLI 220 (e.g., downlink-to-uplink interference) from the base station 105-b. In some examples, the CLI 220 may occur when the base station 105-b is transmitting downlink signals to the UE 115-b at the same time the base station 105-a is receiving uplink signals from the UE 115-a.

To mitigate the CLI 220 between the base station 105-a and the base station 105-b, the base station 105-a (e.g., the victim base station) may measure a CLI channel and perform interference cancellation procedures. Given that the base station 105-a may receive interference from multiple aggressor base stations (e.g., including the base station 105-b), the base station 105-a may implement the described techniques to reduce signaling overhead associated with the CLI channel measurement for multiple aggressor base stations. In some examples, the base station 105-a may identify one or more aggressor base station (e.g., dominant aggressor base stations), where a dominant aggressor base station may be an aggressor base station with interfering signals that satisfy an interference threshold (e.g., an interference power threshold) at the base station 105-a. For example, the base station 105-a may receive a first set of reference signals 225 from each of one or more aggressor base stations including the base station 105-b. The base station 105-a may identify that the base station 105-b is a dominant aggressor base station based on receiving the first set of reference signals 225, which may include RIM reference signals.

In some cases, the base station 105-a may transmit one or more reference signals to the aggressor base stations including the base station 105-b based on an uplink signal of the base station 105-a being affected by CLI. The base station 105-a may receive additional reference signals from the first set of reference signals 225 that satisfy a threshold interference level in response to the reference signals transmitted by the base station 105-a, which the base station 105-a may use to identify the base station 105-b (e.g., the dominant aggressor base station). In some examples, the base station 105-a may use a procedure to identify aggressor base stations which may include receiving RIM reference signals or other reference signals with identifiers associated with one or more aggressor base stations. In particular, the reference signals transmitted by the base station 105-b may include an identifier of the base station 105-b, which may be used by base station 105-a to identify the base station 105-a. Additionally or alternatively, the base station 105-b may use a RIM procedure to identify the base station 105-a.

Upon identifying the base station 105-b as the dominant aggressor base station, the base station 105-a and the base station 105-b may exchange signaling to configure various parameters for CLI channel measurements at the base station 105-a. In some examples, the base stations 105 may use a backhaul link 235 to coordinate a CLI channel measurement and configure various parameters for the CLI channel measurement (e.g., which reference signals may be transmitted by the base station 105-b, time and frequency resources used for the reference signals, and whether the reference signals are to be transmitted via a single port or multiple ports, among other parameters). In some examples, the base station 105-b may transmit one or more reference signals from a second set of reference signals 230 associated with the CLI channel measurements to the base station 105-a. The second set of reference signals 230 may include one or more of a CSI-RS, an SSB, a demodulation reference signal (DMRS), or any combination thereof. The base station 105-a may measure the second set of reference signals 230 to obtain the CLI channel measurements.

The base station 105-a may transmit a measurement report indicating the CLI channel measurements to the base station 105-b via the backhaul link 235. The measurement report may explicitly indicate the CLI channel measurements, where the explicit indication may be compressed or uncompressed. Additionally or alternatively, the measurement report may include channel statistics such as CLI metrics, a received signal strength indicator (RSSI), a reference signal received power (RSRP), or any combination thereof. In some cases, the base station 105-a and the base station 105-b may use the CLI channel measurements to perform one or more CLI mitigation procedures, which may include receive nulling (e.g., beamforming nulling and digital interference cancellation) among other mitigation techniques.

In some cases, the base station 105-a may identify a QCL relationship between the first set of reference signals 225 (e.g., used to identify the one or more aggressor base stations) and the second set of reference signals 230 (e.g., used for performing CLI channel measurements). The base station 105-a may use the CLI channel measurements to estimate a dominant direction of beams used by the base station 105-b based on the QCL relationship. For example, the base station 105-a may determine one or more beam directions used by the second base station 105-b for transmitting the downlink 210 based on the QCL relationship. The base station 105-a and the base station 105-b may use CLI mitigation procedures that are based on the one or more beam directions.

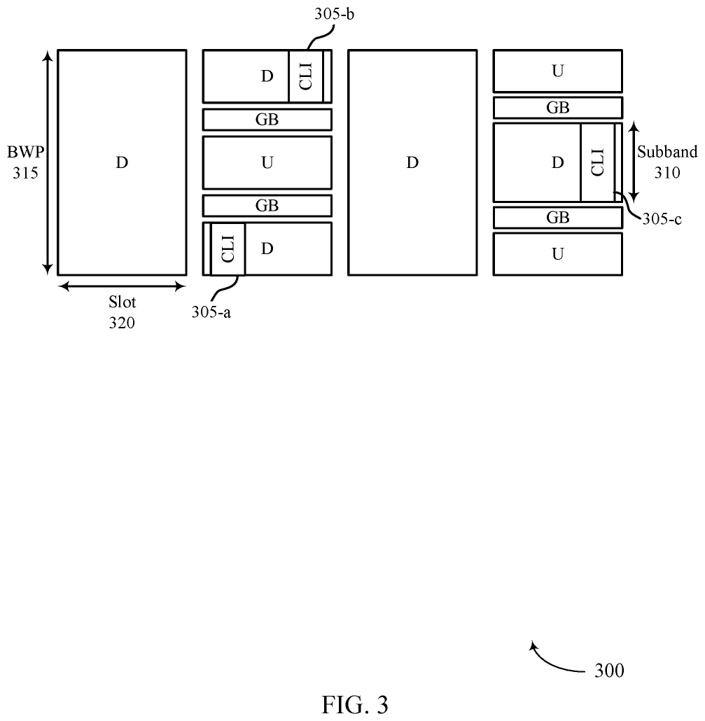

FIG. 3 illustrates an example of a resource allocation 300 that supports inter-base station CLI channel measurements in accordance with aspects of the present disclosure. In some examples, the resource allocation 300 may be implemented by aspects of the wireless communications systems 100 and 200. For example, the resource allocation 300 may be used by a victim base station, and the resource allocation 300 may include downlink resources (e.g., D), uplink resources (e.g., U), guard bands (e.g., GB), and one or more occasions of CLI channel measurements 305 (e.g., corresponding to resources including respective reference signals). In some examples, the resource allocation 300 may support full-duplex communications, where a device may transmit and receive messages in respective subbands 310 of a BWP 315.

As described herein, a victim base station may perform a CLI channel measurement 305 (e.g., CLI channel measurements 305-a, 305-b, 305-c) and interference cancellation procedures to mitigate CLI between the victim base station and an aggressor base station (e.g., a dominant aggressor base station of multiple aggressor base stations). As illustrated, each CLI channel measurement may correspond to time/frequency resources (e.g., one or more symbols in a subband 310) that include a reference signal configured for the CLI channel measurements. Thus, after identifying an aggressor base station, such as described with reference to FIG. 2, the victim base station may receive one or more reference signals associated with CLI channel measurements 305 from the aggressor base station. The victim base station may perform a CLI channel measurement 305 for the identified aggressor base station using the received one or more reference signals.

The victim base station may allocate resources (e.g., or may be configured with the resources) for downlink transmission, uplink reception, and the CLI channel measurements 305, where different subbands 310 in the resource allocation 300 may be configured for full-duplex communications. For example, a first slot 320 (e.g., or any other time interval) may include a downlink resource (e.g., D) that spans an entire BWP 315. In some examples, one or more downlink resources, one or more uplink resources (e.g., U), and multiple guard bands (e.g., GB) between the downlink resources and uplink resources may each span an entire slot 320 and a portion of the BWP 315. The victim base station may perform CLI channel measurements 305 on the same BWP 315 as a downlink resource but using multiple symbols within the slot 320 (e.g., instead of the entire slot 320). For example, the victim base station may perform a CLI channel measurement 305-a for a first subband 310 (e.g., subband 0) and a CLI channel measurement 305-b for a second, different subband 310 (e.g., subband 2), where each CLI channel measurement 305-a, 305-b may occur between downlink resources in the slot 320. In some examples, the victim base station may perform a CLI channel measurement 305-c for a third subband 310 (e.g., subband 1) on a number of symbols of a slot 320 before or after a downlink resource.

In some examples, after performing a CLI channel measurement 305, the victim base station may transmit feedback to the aggressor base station (e.g., via a backhaul link), which the aggressor base station may use to perform transmit beamforming, beam restriction, or both to improve isolation between the victim base station and the aggressor base station. In some cases, the victim base station may provide explicit channel feedback to the aggressor base station. For example, the victim base station may feedback the raw (e.g., compressed, uncompressed) CLI channel to the aggressor base station, and the aggressor base station may use the CLI channel feedback to optimize precoding to minimize or reduce signaling leakage in the direction of the victim base station. Additionally or alternatively, the victim base station may transmit implicit channel feedback to the aggressor base station. For example, the victim base station may use a CLI channel measurement 305 to extract channel statistics or some CLI metrics (e.g., RSSI, RSRP), which may assist the aggressor base station in beam selection.

In some cases, the victim base station may use a combiner codebook for performing the CLI channel measurements, where the combiner codebook may include respective combiners (e.g., combiner matrices) used across different CLI channel measurements 305. To reduce the overhead of combiner generation, the victim base station may use a set of predefined combiners in a combining codebook. In some examples, the victim base station may define a receive-combiner codebook and use one or more receive combiners from the codebook to perform the CLI channel measurements 305. For example, the victim base station may select one or more combiner matrices based on the combiner codebook which includes a set of two or more combiner matrices. The victim base station may measure one or more reference signals from the aggressor base station using the one or more combiner matrices in a first subband 310 (e.g., the CLI channel measurement 305-a), and the victim base station may measure one or more additional reference signals from the aggressor base station using the one or more combiner matrices in a second subband 310 (e.g., the CLI channel measurement 305-c). In some examples, for each subband 310, the victim base station may select a respective combiner matrix that is associated with a threshold level of CLI based on the CLI channel measurements 305. As such, the victim base station may measure respective reference signals received in each subband 310 of a set of subbands 310 to obtain the CLI channel measurements 305.

In some examples, the victim base station may use different receive combiners to identify a beam direction for the aggressor base station (e.g., QCL-downlink (D) in frequency range 2 (FR2)). For each subband 310, the victim base station may measure CLI interference using a particular receive combiner based on the codebook, and as such, the victim base station may identify an optimal combiner (e.g., digital, analog) per subband 310. In some examples, a CLI channel measurement 305 may depend on a signal, channel, or both (e.g., a CSI-RS, an SSB, a physical downlink shared channel (PDSCH)-DMRS) transmitted by the aggressor base station, which may impact whether the victim base station performs single-port CLI channel measurements (e.g., for an SSB) or multi-port CLI channel measurements (e.g., for a CSI-RS). That is, the victim base station may perform the CLI channel measurements 305 using a single-port measurement scheme or a multi-port measurement scheme, or both, based on the type of reference signal transmitted from the aggressor base station.

In some examples, the victim base station and the aggressor base station may communicate over a semi-static channel, where transmission occasions may be configured in an RRC configuration shared by the victim base station and the aggressor base station. The victim base station and the aggressor base station may communicate signaling to coordinate communications from each base station to mitigate CLI. Coordination overhead for the semi-static channel may be relatively more manageable (e.g., may use relatively less signaling overhead, relatively fewer resources) than coordinated scheduling overhead for dynamic channels, as semi-static channels may have one or more preconfigured patterns. For example, a configured grant (CG) physical uplink shared channel (PUSCH) (CG-PUSCH) and a physical uplink control channel (PUCCH) (e.g., including uplink control information (UCI)) may be transmitted in the uplink in response to semi-persistent scheduling (SPS), and an SPS-PDSCH may be transmitted in the downlink (e.g., in accordance with some periodicity). In such cases, the victim base station may communicate signaling with the aggressor base station that indicates a resource allocation, one or more directional beams, or both used by the victim base station and the aggressor base station for periodic transmissions (e.g., to/from one or more UEs). The resource allocation, the directional beams, a schedule of transmissions, or any combination thereof, may be configured to mitigate CLI at the first base station based on the signaling. In some examples, the signaling may additionally include an indication of one or more patterns corresponding to the periodic transmissions, where the CLI mitigation may be based on the patterns. As such, these transmissions and associated transmission occasions may be known in advance and shared by the victim base station and the aggressor base station.

Additionally or alternatively, the victim base station and the aggressor base station may coordinate on time resources, frequency resources, spatial resources, or any combination thereof. That is, the victim base station may perform resource allocation coordination for semi-static channels in conjunction with beam coordination, CLI mitigation, or both, and the aggressor base station may perform resource allocation coordination for semi-static channels in conjunction with CLI minimization. In some examples, since the patterns of the semi-static channel are semi-static (e.g., patterns may be exchanged over an X2 interface), the victim base station and the aggressor base station may exchange an update if a resource is activated or deactivated.

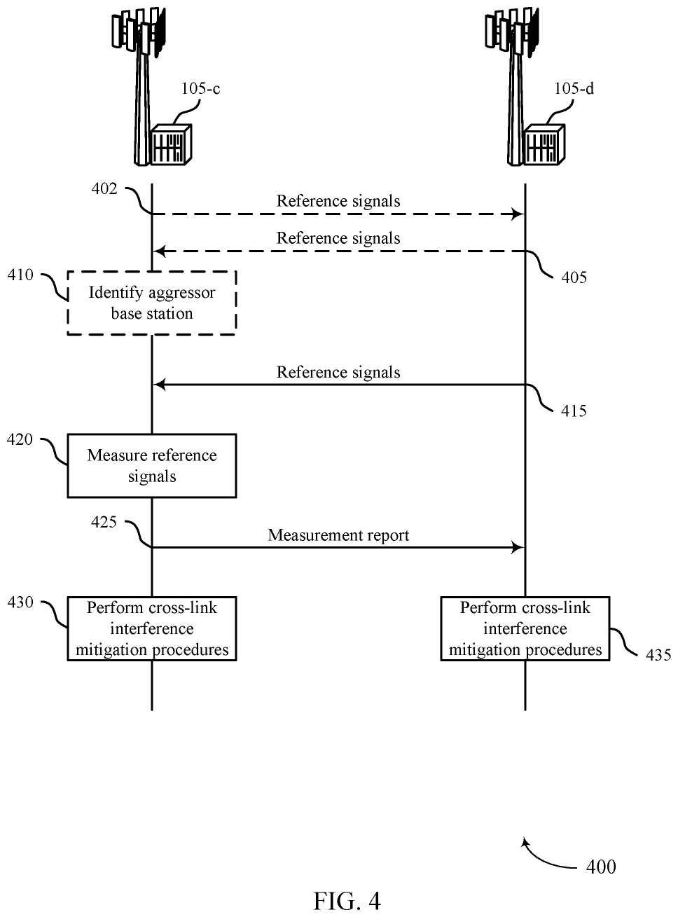

FIG. 4 illustrates an example of a process flow 400 in a system that supports inter-base station CLI channel measurements in accordance with aspects of the present disclosure. The process flow 400 may implement aspects of wireless communications systems 100 and 200, or may be implemented by aspects of the wireless communications system 100 and 200. For example, the process flow 400 may illustrate operations between a base station 105-c and a base station 105-d, which may be examples of corresponding devices described herein. In the following description of the process flow 400, the operations between the base station 105-c and the base station 105-d may be transmitted in a different order than the example order shown, or the operations performed by the base station 105-c, and the base station 105-d may be performed in different orders or at different times. Some operations may also be omitted from the process flow 400, and other operations may be added to the process flow 400.

At 402, the base station 105-c (e.g., a victim base station) may detect CLI from one or more transmissions from the base station 105-d (e.g., an aggressor base station). In such cases, the base station 105-c may transmit a first set of reference signals to the base station 105-d (and to one or more other aggressor base stations from a set of aggressor base stations). In such cases, the base station 105-d may identify the base station 105-c as a victim base station, and the base station 105-d may respond with a transmission the first set of reference signals. In some examples, the first set of reference signals may include RIM reference signals or other types of reference signals.

Thus, at 405, the base station 105-c may receive the first set of reference signals from each aggressor base station from the set of one or more aggressor base station, including the base station 105-d. Each aggressor base station from the set of one or more aggressor base stations may transmit downlink signals that interfere with uplink signals at the base station 105-c. In some examples, the base station 105-d may transmit the first set of reference signals without first receiving the reference signals from the base station 105-c. That is, the base station 105-d may transmit the first set of reference signals (e.g., RIM-like reference signals) to the base station 105-c to enable the base station 105-c to identify the base station 105-d as an aggressor base station. In either case, at 410, the base station 105-c may identify the base station 105-d (e.g., an aggressor base station) based on receiving the first set of reference signals.

At 415, the base station 105-c may receive, from the base station 105-d from a set of one or more aggressor base stations, a second set of reference signals associated with CLI channel measurements. The second set of reference signals may include one or more of a CSI-RS, an SSB, a DMRS, or any combination thereof.

At 420, the base station 105-c may measure the second set of reference signals to obtain the CLI channel measurements. For example, the base station 105-c may measure respective reference signals received in each subband of a set of subbands to obtain the CLI channel measurements. In addition, the base station 105-c may measure the second set of reference signals using a single-port measurement scheme, a multi-port measurement scheme, or both based on the type of reference signal.

At 425, base station 105-c may transmit, to the base station 105-d, a measurement report including an indication of the CLI channel measurements. The measurement report may include an explicit indication of the CLI channel measurements (e.g., compressed or uncompressed), or the measurement report may include channel statics, CLI metrics, or both (e.g., RSSI, RSRP). In some cases, the base station 105-c may transmit the measurement report to the base station 105-d via a backhaul link.

At 430, the base station 105-c may perform one or more CLI mitigation procedures based on the CLI channel measurements. The CLI mitigation procedures may include beamforming nulling (e.g., receive nulling), combiner modification, interference cancellation, or any combination thereof at the base station 105-c.

At 435, the base station 105-d may perform one or more CLI management procedures based on the CLI channel measurements. The CLI management procedures may include beamforming modification (e.g., transmit beamforming modification), precoder modification, directional beam restriction, or any combination thereof at the base station 105-d.

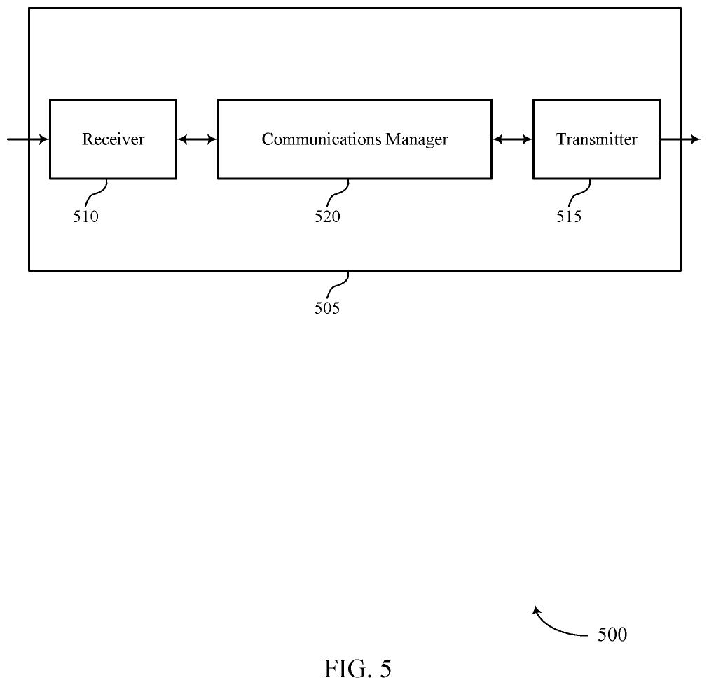

FIG. 5 shows a block diagram 500 of a device 505 that supports inter-base station CLI channel measurements in accordance with aspects of the present disclosure. The device 505 may be an example of aspects of a base station 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to inter-base station CLI channel measurements). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to inter-base station CLI channel measurements). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of inter-base station CLI channel measurements as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first base station in accordance with examples as disclosed herein. For example, the communications manager 520 may be configured as or otherwise support a means for receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The communications manager 520 may be configured as or otherwise support a means for measuring the first set of reference signals to obtain the CLI channel measurements. The communications manager 520 may be configured as or otherwise support a means for performing one or more CLI mitigation procedures based on the CLI channel measurements.

Additionally or alternatively, the communications manager 520 may support wireless communication at a first base station in accordance with examples as disclosed herein. For example, the communications manager 520 may be configured as or otherwise support a means for transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station. The communications manager 520 may be configured as or otherwise support a means for receiving, from the second base station, a measurement report including an indication of CLI channel measurements that are based on the first set of reference signals. The communications manager 520 may be configured as or otherwise support a means for performing one or more CLI management procedures based on the CLI channel measurements.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for inter-base station CLI channel measurements, which may reduce signaling overhead and improve communications between base stations.

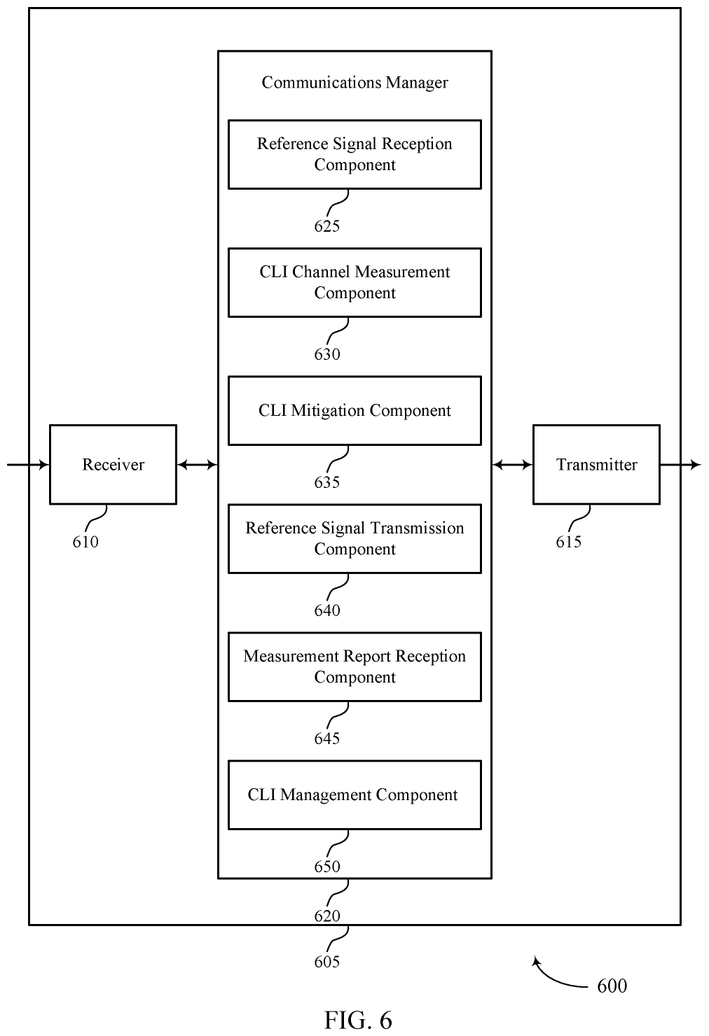

FIG. 6 shows a block diagram 600 of a device 605 that supports inter-base station CLI channel measurements in accordance with aspects of the present disclosure. The device 605 may be an example of aspects of a device 505 or a base station 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to inter-base station CLI channel measurements). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inter-base station CLI channel measurements). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of inter-base station CLI channel measurements as described herein. For example, the communications manager 620 may include a reference signal reception component 625, a CLI channel measurement component 630, a CLI mitigation component 635, a reference signal transmission component 640, a measurement report reception component 645, a CLI management component 650, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first base station in accordance with examples as disclosed herein. The reference signal reception component 625 may be configured as or otherwise support a means for receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The CLI channel measurement component 630 may be configured as or otherwise support a means for measuring the first set of reference signals to obtain the CLI channel measurements. The CLI mitigation component 635 may be configured as or otherwise support a means for performing one or more CLI mitigation procedures based on the CLI channel measurements.

Additionally or alternatively, the communications manager 620 may support wireless communication at a first base station in accordance with examples as disclosed herein. The reference signal transmission component 640 may be configured as or otherwise support a means for transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station. The measurement report reception component 645 may be configured as or otherwise support a means for receiving, from the second base station, a measurement report including an indication of CLI channel measurements that are based on the first set of reference signals. The CLI management component 650 may be configured as or otherwise support a means for performing one or more CLI management procedures based on the CLI channel measurements.

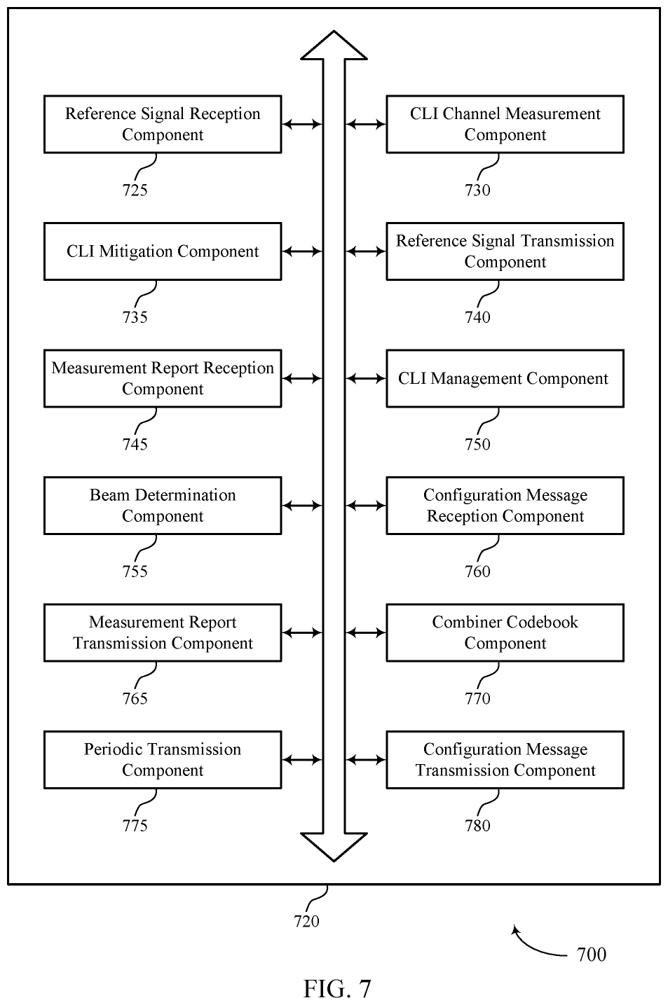

FIG. 7 shows a block diagram 700 of a communications manager 720 that supports inter-base station CLI channel measurements in accordance with aspects of the present disclosure. The communications manager 720 may be an example of aspects of a communications manager 520, a communications manager 620, or both, as described herein. The communications manager 720, or various components thereof, may be an example of means for performing various aspects of inter-base station CLI channel measurements as described herein. For example, the communications manager 720 may include a reference signal reception component 725, a CLI channel measurement component 730, a CLI mitigation component 735, a reference signal transmission component 740, a measurement report reception component 745, a CLI management component 750, a beam determination component 755, a configuration message reception component 760, a measurement report transmission component 765, a combiner codebook component 770, a periodic transmission component 775, a configuration message transmission component 780, or any combination thereof. Each of these components may communicate, directly or indirectly, with one another (e.g., via one or more buses).

The communications manager 720 may support wireless communication at a first base station in accordance with examples as disclosed herein. The reference signal reception component 725 may be configured as or otherwise support a means for receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The CLI channel measurement component 730 may be configured as or otherwise support a means for measuring the first set of reference signals to obtain the CLI channel measurements. The CLI mitigation component 735 may be configured as or otherwise support a means for performing one or more CLI mitigation procedures based on the CLI channel measurements.

In some examples, the reference signal reception component 725 may be configured as or otherwise support a means for transmitting, to each aggressor base station from the set of one or more aggressor base stations, one or more reference signals of the second set of reference signals based on an uplink signal of the first base station being affected by CLI. In some examples, the reference signal reception component 725 may be configured as or otherwise support a means for receiving, from each aggressor base station from the set of one or more aggressor base stations, one or more additional reference signals of the second set of reference signals in response to the transmitted one or more reference signals, where the second base station is identified based on one or more additional reference signals received from the second base station satisfying a threshold interference level.

In some examples, the reference signal reception component 725 may be configured as or otherwise support a means for receiving one or more reference signals of the second set of reference signals from the second base station, the one or more reference signals including an identifier of the second base station, where the second base station is identified based on the identifier or the second base station and the one or more reference signals from the second base station satisfying a threshold interference level.

In some examples, the beam determination component 755 may be configured as or otherwise support a means for determining one or more beam directions used by the second base station for transmitting the downlink signals based on a QCL relationship between the first set of reference signals and the second set of reference signals, where the one or more CLI mitigation procedures are based on the one or more beam directions.

In some examples, the configuration message reception component 760 may be configured as or otherwise support a means for receiving, from the second base station, a message indicating a configuration of the first set of reference signals, where the configuration of the first set of reference signals includes one or more types of reference signals used for the first set of reference signals, time and frequency resources associated with the first set of reference signals, port information associated with the first set of reference signals, or any combination thereof.

In some examples, the message indicating the configuration of the first set of reference signals is received over a backhaul link between the first base station and the second base station.

In some examples, the measurement report transmission component 765 may be configured as or otherwise support a means for transmitting, to the second base station, a measurement report including an indication of the CLI channel measurements. In some examples, indication of the CLI channel measurements includes an explicit indication of the CLI channel measurements, the explicit indication being compressed or uncompressed.

In some examples, the indication of the CLI channel measurements includes one or more channel statistics, one or more CLI metrics, an RSSI, an RSRP, or any combination thereof. In some examples, the measurement report is transmitted over a backhaul link between the first base station and the second base station.

In some examples, to support measuring the first set of reference signals, the combiner codebook component 770 may be configured as or otherwise support a means for selecting one or more combiner matrices based on a combiner codebook that includes a set of two or more combiner matrices. In some examples, to support measuring the first set of reference signals, the CLI channel measurement component 730 may be configured as or otherwise support a means for measuring, in a first subband, one or more reference signals of the first set of reference signals using the one or more combiner matrices. In some examples, to support measuring the first set of reference signals, the CLI channel measurement component 730 may be configured as or otherwise support a means for measuring, in a second subband, one or more additional reference signals of the first set of reference signals using the one or more combiner matrices.

In some examples, the combiner codebook component 770 may be configured as or otherwise support a means for selecting, for each of the first subband and the second subband, a respective combiner matrix from the one or more combiner matrices that is associated with a threshold level of CLI based on measuring the one or more reference signals and the one or more additional reference signals.

In some examples, the periodic transmission component 775 may be configured as or otherwise support a means for communicating signaling with the second base station that indicates a resource allocation, or one or more directional beams, or both, used by the first base station and the second base station for periodic transmissions to one or more other devices, where the resource allocation, or the one or more directional beams, or both, are configured to mitigate CLI at the first base station based on the signaling.

In some examples, the signaling includes an indication of one or more patterns corresponding to the periodic transmissions, and where mitigation of the CLI is based on the one or more patterns.

In some examples, to support measuring the first set of reference signals, the CLI channel measurement component 730 may be configured as or otherwise support a means for measuring respective reference signals received in each subband of a set of subbands to obtain the CLI channel measurements.

In some examples, the set of subbands are configured for full-duplex communications. In some examples, the one or more CLI mitigation procedures include beamforming nulling, combiner modification, interference cancellation, or any combination thereof.

In some examples, the first set of reference signals include one or more types of reference signals, the one or more types of reference signals including a CSI-RS, an SSB, a DMRS, or any combination thereof.

In some examples, to support measuring the first set of reference signals, the CLI channel measurement component 730 may be configured as or otherwise support a means for measuring the first set of reference signals using a single-port measurement scheme or a multi-port measurement scheme, or both, based on the one or more types of reference signals.

Additionally or alternatively, the communications manager 720 may support wireless communication at a first base station in accordance with examples as disclosed herein. The reference signal transmission component 740 may be configured as or otherwise support a means for transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station. The measurement report reception component 745 may be configured as or otherwise support a means for receiving, from the second base station, a measurement report including an indication of CLI channel measurements that are based on the first set of reference signals. The CLI management component 750 may be configured as or otherwise support a means for performing one or more CLI management procedures based on the CLI channel measurements.

In some examples, the reference signal transmission component 740 may be configured as or otherwise support a means for receiving, from the second base station, one or more reference signals of the second set of reference signals based on an uplink signal of the first base station being affected by CLI from downlink signals from the first base station. In some examples, the reference signal transmission component 740 may be configured as or otherwise support a means for transmitting, to the second base station, one or more additional reference signals of the second set of reference signals in response to the received one or more reference signals, where the measurement report is received based on one or more additional reference signals transmitted to the second base station satisfying a threshold interference level.

In some examples, the reference signal transmission component 740 may be configured as or otherwise support a means for transmitting, to the second base station, one or more reference signals of the second set of reference signals, the one or more reference signals including an identifier of the first base station, where the measurement report is received based on the identifier or the first base station and the one or more reference signals transmitted to the second base station satisfying a threshold interference level.

In some examples, the configuration message transmission component 780 may be configured as or otherwise support a means for transmitting, to the second base station, a message indicating a configuration of the first set of reference signals, where the configuration of the first set of reference signals includes one or more types of reference signals used for the first set of reference signals, time and frequency resources associated with the first set of reference signals, port information associated with the first set of reference signals, or any combination thereof.

In some examples, the message indicating the configuration of the first set of reference signals is received over a backhaul link between the first base station and the second base station.

In some examples, the indication of the CLI channel measurements includes one or more channel statistics, one or more CLI metrics, an RSSI, an RSRP, or any combination thereof.

In some examples, the periodic transmission component 775 may be configured as or otherwise support a means for communicating signaling with the second base station that indicates a resource allocation, or one or more directional beams, or both, used by the first base station and the second base station for periodic transmissions to one or more other devices, where the resource allocation, or the one or more directional beams, or both, are configured to mitigate CLI at the first base station based on the signaling.

In some examples, the measurement report is received over a backhaul link between the first base station and the second base station. In some examples, the one or more CLI management procedures include beamforming modification, precoder modification, directional beam restriction, or any combination thereof.

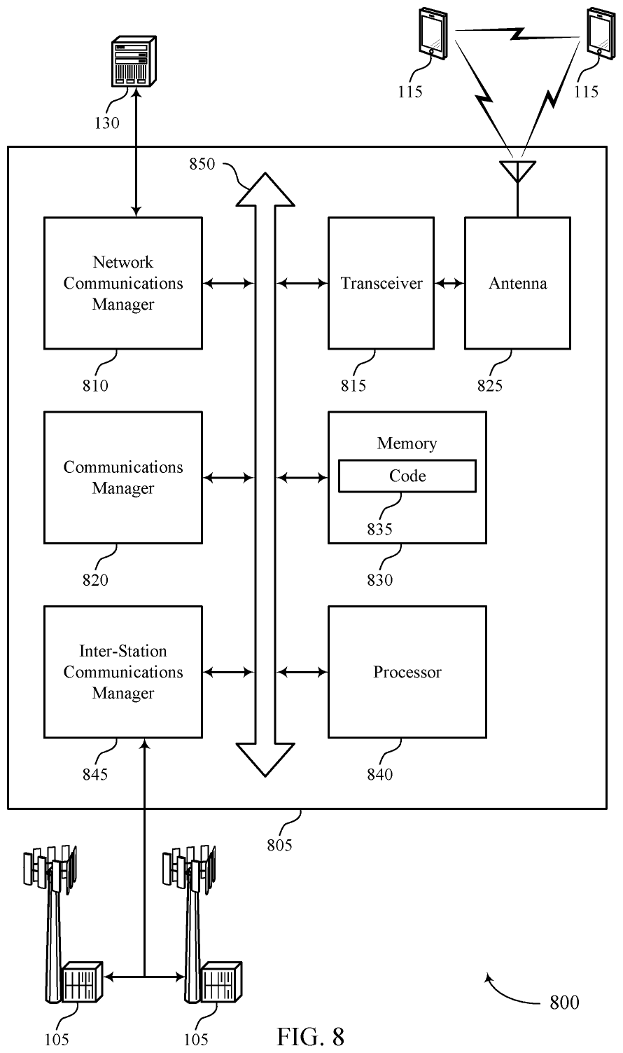

FIG. 8 shows a diagram of a system 800 including a device 805 that supports inter-base station CLI channel measurements in accordance with aspects of the present disclosure. The device 805 may be an example of or include the components of a device 505, a device 605, or a base station 105 as described herein. The device 805 may communicate wirelessly with one or more base stations 105, UEs 115, or any combination thereof. The device 805 may include components for bi-directional voice and data communications including components for transmitting and receiving communications, such as a communications manager 820, a network communications manager 810, a transceiver 815, an antenna 825, a memory 830, code 835, a processor 840, and an inter-station communications manager 845. These components may be in electronic communication or otherwise coupled (e.g., operatively, communicatively, functionally, electronically, electrically) via one or more buses (e.g., a bus 850).

The network communications manager 810 may manage communications with a core network 130 (e.g., via one or more wired backhaul links). For example, the network communications manager 810 may manage the transfer of data communications for client devices, such as one or more UEs 115.

In some cases, the device 805 may include a single antenna 825. However, in some other cases the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic input/output system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting inter-base station CLI channel measurements). For example, the device 805 or a component of the device 805 may include a processor 840 and memory 830 coupled with the processor 840, the processor 840 and memory 830 configured to perform various functions described herein.

The inter-station communications manager 845 may manage communications with other base stations 105, and may include a controller or scheduler for controlling communications with UEs 115 in cooperation with other base stations 105. For example, the inter-station communications manager 845 may coordinate scheduling for transmissions to UEs 115 for various interference mitigation techniques such as beamforming or joint transmission. In some examples, the inter-station communications manager 845 may provide an X2 interface within an LTE/LTE-A wireless communications network technology to provide communication between base stations 105.

The communications manager 820 may support wireless communication at a first base station in accordance with examples as disclosed herein. For example, the communications manager 820 may be configured as or otherwise support a means for receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The communications manager 820 may be configured as or otherwise support a means for measuring the first set of reference signals to obtain the CLI channel measurements. The communications manager 820 may be configured as or otherwise support a means for performing one or more CLI mitigation procedures based on the CLI channel measurements.

Additionally or alternatively, the communications manager 820 may support wireless communication at a first base station in accordance with examples as disclosed herein. For example, the communications manager 820 may be configured as or otherwise support a means for transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station. The communications manager 820 may be configured as or otherwise support a means for receiving, from the second base station, a measurement report including an indication of CLI channel measurements that are based on the first set of reference signals. The communications manager 820 may be configured as or otherwise support a means for performing one or more CLI management procedures based on the CLI channel measurements.

By including or configuring the communications manager 820 in accordance with examples as described herein, the device 805 may support techniques for inter-base station CLI channel measurements, which may reduce signaling overhead and improve communications between base stations.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of inter-base station CLI channel measurements as described herein, or the processor 840 and the memory 830 may be otherwise configured to perform or support such operations.

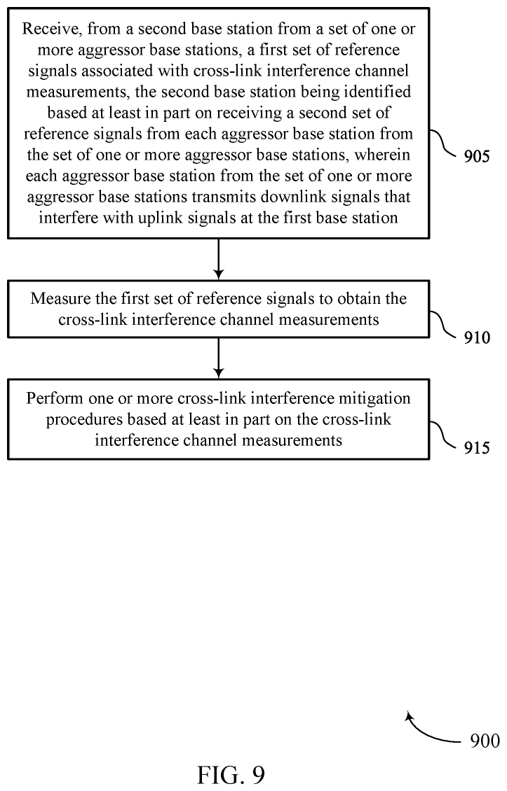

FIG. 9 shows a flowchart illustrating a method 900 that supports inter-base station CLI channel measurements in accordance with aspects of the present disclosure. The operations of the method 900 may be implemented by a base station or its components as described herein. For example, the operations of the method 900 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 905, the method may include receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The operations of 905 may be performed in accordance with examples as disclosed herein. In some examples, aspects of the operations of 905 may be performed by a reference signal reception component 725 as described with reference to FIG. 7.

At 910, the method may include measuring the first set of reference signals to obtain the CLI channel measurements. The operations of 910 may be performed in accordance with examples as disclosed herein. In some examples, aspects of the operations of 910 may be performed by a CLI channel measurement component 730 as described with reference to FIG. 7.

At 915, the method may include performing one or CLI mitigation procedures based on the CLI channel measurements. The operations of 915 may be performed in accordance with examples as disclosed herein. In some examples, aspects of the operations of 915 may be performed by a CLI mitigation component 735 as described with reference to FIG. 7.

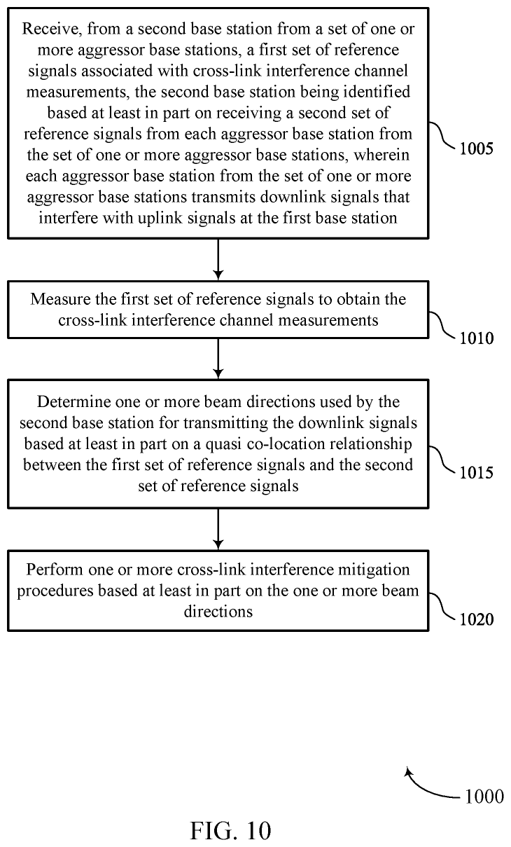

FIG. 10 shows a flowchart illustrating a method 1000 that supports inter-base station CLI channel measurements in accordance with aspects of the present disclosure. The operations of the method 1000 may be implemented by a base station or its components as described herein. For example, the operations of the method 1000 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1005, the method may include receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The operations of 1005 may be performed in accordance with examples as disclosed herein. In some examples, aspects of the operations of 1005 may be performed by a reference signal reception component 725 as described with reference to FIG. 7.

At 1010, the method may include measuring the first set of reference signals to obtain the CLI channel measurements. The operations of 1010 may be performed in accordance with examples as disclosed herein. In some examples, aspects of the operations of 1010 may be performed by a CLI channel measurement component 730 as described with reference to FIG. 7.

At 1015, the method may include determining one or more beam directions used by the second base station for transmitting the downlink signals based on a QCL relationship between the first set of reference signals and the second set of reference signals. The operations of 1015 may be performed in accordance with examples as disclosed herein. In some examples, aspects of the operations of 1015 may be performed by a beam determination component 755 as described with reference to FIG. 7.

At 1020, the method may include performing one or more CLI mitigation procedures based on the one or more beam directions. The operations of 1020 may be performed in accordance with examples as disclosed herein. In some examples, aspects of the operations of 1020 may be performed by a CLI mitigation component 735 as described with reference to FIG. 7.

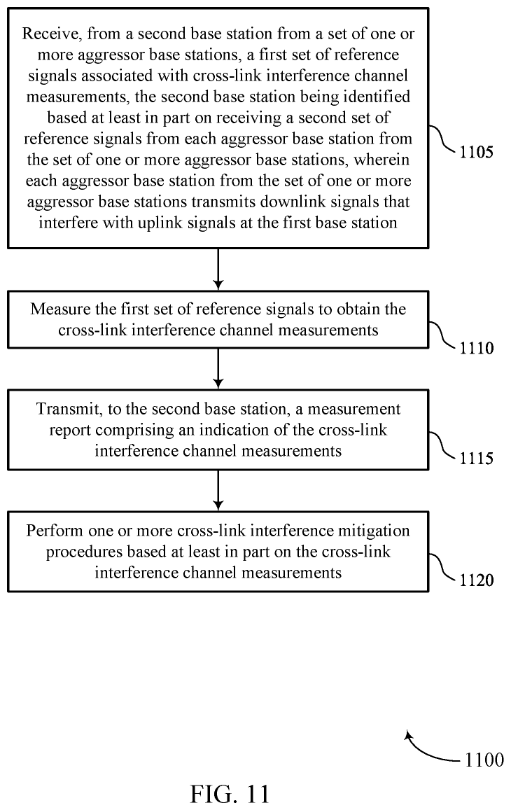

FIG. 11 shows a flowchart illustrating a method 1100 that supports inter-base station CLI channel measurements in accordance with aspects of the present disclosure. The operations of the method 1100 may be implemented by a base station or its components as described herein. For example, the operations of the method 1100 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1105, the method may include receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The operations of 1105 may be performed in accordance with examples as disclosed herein. In some examples, aspects of the operations of 1105 may be performed by a reference signal reception component 725 as described with reference to FIG. 7.

At 1110, the method may include measuring the first set of reference signals to obtain the CLI channel measurements. The operations of 1110 may be performed in accordance with examples as disclosed herein. In some examples, aspects of the operations of 1110 may be performed by a CLI channel measurement component 730 as described with reference to FIG. 7.

At 1115, the method may include transmitting, to the second base station, a measurement report including an indication of the CLI channel measurements. The operations of 1115 may be performed in accordance with examples as disclosed herein. In some examples, aspects of the operations of 1115 may be performed by a measurement report transmission component 765 as described with reference to FIG. 7.

At 1120, the method may include performing one or more CLI mitigation procedures based on the CLI channel measurements. The operations of 1120 may be performed in accordance with examples as disclosed herein. In some examples, aspects of the operations of 1120 may be performed by a CLI mitigation component 735 as described with reference to FIG. 7.

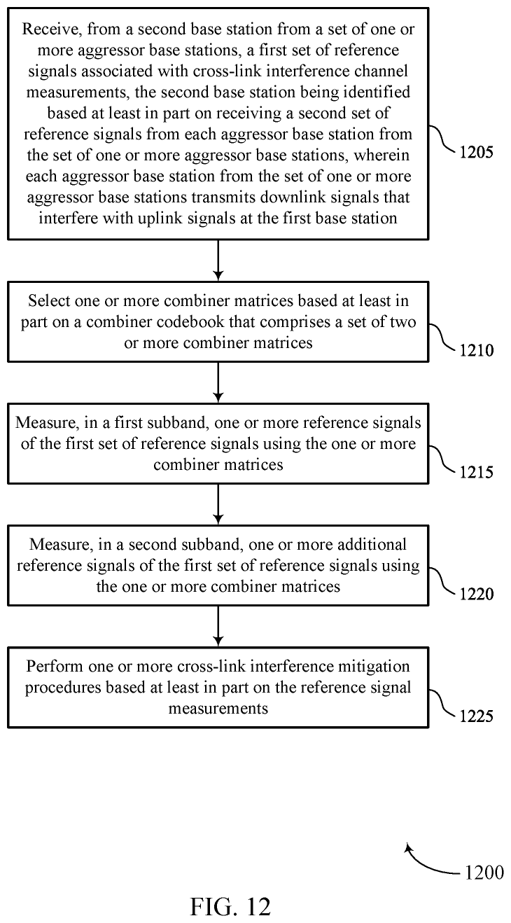

FIG. 12 shows a flowchart illustrating a method 1200 that supports inter-base station CLI channel measurements in accordance with aspects of the present disclosure. The operations of the method 1200 may be implemented by a base station or its components as described herein. For example, the operations of the method 1200 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1205, the method may include receiving, from a second base station from a set of one or more aggressor base stations, a first set of reference signals associated with CLI channel measurements, the second base station being identified based on receiving a second set of reference signals from each aggressor base station from the set of one or more aggressor base stations, where each aggressor base station from the set of one or more aggressor base stations transmits downlink signals that interfere with uplink signals at the first base station. The operations of 1205 may be performed in accordance with examples as disclosed herein. In some examples, aspects of the operations of 1205 may be performed by a reference signal reception component 725 as described with reference to FIG. 7.

At 1210, the method may include selecting one or more combiner matrices based on a combiner codebook that includes a set of two or more combiner matrices. The operations of 1210 may be performed in accordance with examples as disclosed herein. In some examples, aspects of the operations of 1210 may be performed by a combiner codebook component 770 as described with reference to FIG. 7.

At 1215, the method may include measuring, in a first subband, one or more reference signals of the first set of reference signals using the one or more combiner matrices. The operations of 1215 may be performed in accordance with examples as disclosed herein. In some examples, aspects of the operations of 1215 may be performed by a CLI channel measurement component 730 as described with reference to FIG. 7.

At 1220, the method may include measuring, in a second subband, one or more additional reference signals of the first set of reference signals using the one or more combiner matrices. The operations of 1220 may be performed in accordance with examples as disclosed herein. In some examples, aspects of the operations of 1220 may be performed by a CLI channel measurement component 730 as described with reference to FIG. 7.

At 1225, the method may include performing one or more CLI mitigation procedures based on the reference signal measurements. The operations of 1225 may be performed in accordance with examples as disclosed herein. In some examples, aspects of the operations of 1225 may be performed by a CLI mitigation component 735 as described with reference to FIG. 7.

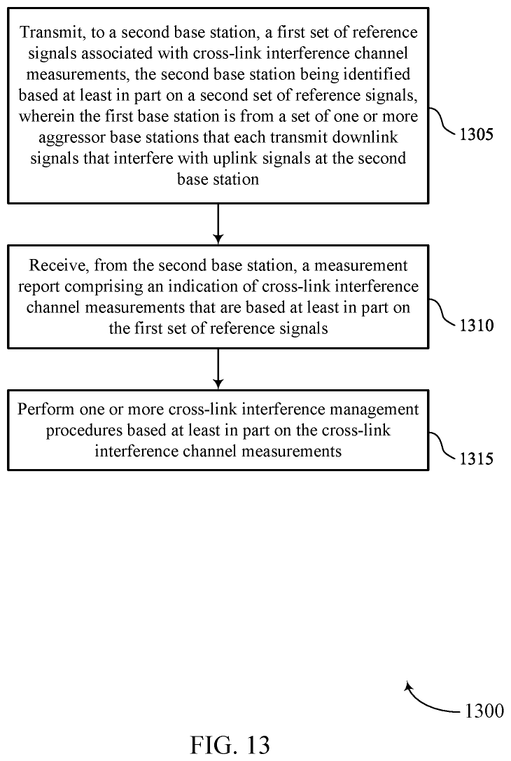

FIG. 13 shows a flowchart illustrating a method 1300 that supports inter-base station CLI channel measurements in accordance with aspects of the present disclosure. The operations of the method 1300 may be implemented by a base station or its components as described herein. For example, the operations of the method 1300 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1305, the method may include transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station. The operations of 1305 may be performed in accordance with examples as disclosed herein. In some examples, aspects of the operations of 1305 may be performed by a reference signal transmission component 740 as described with reference to FIG. 7.

At 1310, the method may include receiving, from the second base station, a measurement report including an indication of CLI channel measurements that are based on the first set of reference signals. The operations of 1310 may be performed in accordance with examples as disclosed herein. In some examples, aspects of the operations of 1310 may be performed by a measurement report reception component 745 as described with reference to FIG. 7.

At 1315, the method may include performing one or more CLI management procedures based on the CLI channel measurements. The operations of 1315 may be performed in accordance with examples as disclosed herein. In some examples, aspects of the operations of 1315 may be performed by a CLI management component 750 as described with reference to FIG. 7.

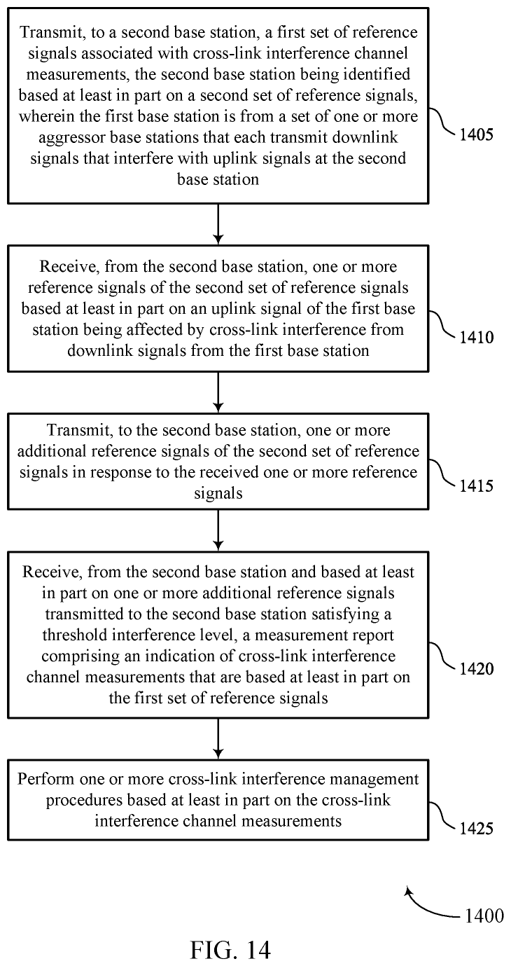

FIG. 14 shows a flowchart illustrating a method 1400 that supports inter-base station CLI channel measurements in accordance with aspects of the present disclosure. The operations of the method 1400 may be implemented by a base station or its components as described herein. For example, the operations of the method 1400 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1405, the method may include transmitting, to a second base station, a first set of reference signals associated with CLI channel measurements, the second base station being identified based on a second set of reference signals, where the first base station is from a set of one or more aggressor base stations that each transmit downlink signals that interfere with uplink signals at the second base station. The operations of 1405 may be performed in accordance with examples as disclosed herein. In some examples, aspects of the operations of 1405 may be performed by a reference signal transmission component 740 as described with reference to FIG. 7.

At 1410, the method may include receiving, from the second base station, one or more reference signals of the second set of reference signals based on an uplink signal of the first base station being affected by CLI from downlink signals from the first base station. The operations of 1410 may be performed in accordance with examples as disclosed herein. In some examples, aspects of the operations of 1410 may be performed by a reference signal transmission component 740 as described with reference to FIG. 7.

At 1415, the method may include transmitting, to the second base station, one or more additional reference signals of the second set of reference signals in response to the received one or more reference signals. The operations of 1415 may be performed in accordance with examples as disclosed herein. In some examples, aspects of the operations of 1415 may be performed by a reference signal transmission component 740 as described with reference to FIG. 7.

At 1420, the method may include receiving, from the second base station and based on one or more additional reference signals transmitted to the second base station satisfying a threshold interference level, a measurement report including an indication of CLI channel measurements that are based on the first set of reference signals. The operations of 1420 may be performed in accordance with examples as disclosed herein. In some examples, aspects of the operations of 1420 may be performed by a measurement report reception component 745 as described with reference to FIG. 7.

At 1425, the method may include performing one or more CLI management procedures based on the CLI channel measurements. The operations of 1425 may be performed in accordance with examples as disclosed herein. In some examples, aspects of the operations of 1425 may be performed by a CLI management component 750 as described with reference to FIG. 7.

The following provides an overview of aspects of the present disclosure:

Aspect 1: A method for wireless communication at a first base station, comprising: receiving, from a second base station from a set of one or more aggressor base stations, a first set of reference signals associated with CLI channel measurements, the second base station being identified based at least in part on receiving a second set of reference signals from each aggressor base station from the set of one or more aggressor base stations, wherein each aggressor base station from the set of one or more aggressor base stations transmits downlink signals that interfere with uplink signals at the first base station; measuring the first set of reference signals to obtain the CLI channel measurements; and performing one or more CLI mitigation procedures based at least in part on the CLI channel measurements.

Aspect 2: The method of aspect 1, further comprising: transmitting, to each aggressor base station from the set of one or more aggressor base stations, one or more reference signals of the second set of reference signals based at least in part on an uplink signal of the first base station being affected by CLI; and receiving, from each aggressor base station from the set of one or more aggressor base stations, one or more additional reference signals of the second set of reference signals in response to the transmitted one or more reference signals, wherein the second base station is identified based at least in part on one or more additional reference signals received from the second base station satisfying a threshold interference level.

Aspect 3: The method of any of aspects 1 through 2, further comprising: receiving one or more reference signals of the second set of reference signals from the second base station, the one or more reference signals comprising an identifier of the second base station, wherein the second base station is identified based at least in part on the identifier or the second base station and the one or more reference signals from the second base station satisfying a threshold interference level.

Aspect 4: The method of any of aspects 1 through 3, further comprising: determining one or more beam directions used by the second base station for transmitting the downlink signals based at least in part on a QCL relationship between the first set of reference signals and the second set of reference signals, wherein the one or more CLI mitigation procedures are based at least in part on the one or more beam directions.

Aspect 5: The method of any of aspects 1 through 4, further comprising: receiving, from the second base station, a message indicating a configuration of the first set of reference signals, wherein the configuration of the first set of reference signals comprises one or more types of reference signals used for the first set of reference signals, time and frequency resources associated with the first set of reference signals, port information associated with the first set of reference signals, or any combination thereof.

Aspect 6: The method of aspect 5, wherein the message indicating the configuration of the first set of reference signals is received over a backhaul link between the first base station and the second base station.

Aspect 7: The method of any of aspects 1 through 6, further comprising: transmitting, to the second base station, a measurement report comprising an indication of the CLI channel measurements.

Aspect 8: The method of aspect 7, wherein the indication of the CLI channel measurements comprises an explicit indication of the CLI channel measurements, the explicit indication being compressed or uncompressed.

Aspect 9: The method of any of aspects 7 through 8, wherein the indication of the CLI channel measurements comprises one or more channel statistics, one or more CLI metrics, an RSSI, an RSRP, or any combination thereof.

Aspect 10: The method of any of aspects 7 through 9, wherein the measurement report is transmitted over a backhaul link between the first base station and the second base station.

Aspect 11: The method of any of aspects 1 through 10, wherein measuring the first set of reference signals comprises: selecting one or more combiner matrices based at least in part on a combiner codebook that comprises a set of two or more combiner matrices; measuring, in a first subband, one or more reference signals of the first set of reference signals using the one or more combiner matrices; and measuring, in a second subband, one or more additional reference signals of the first set of reference signals using the one or more combiner matrices.

Aspect 12: The method of aspect 11, further comprising: selecting, for each of the first subband and the second subband, a respective combiner matrix from the one or more combiner matrices that is associated with a threshold level of CLI based at least in part on measuring the one or more reference signals and the one or more additional reference signals.

Aspect 13: The method of any of aspects 1 through 12, further comprising: communicating signaling with the second base station that indicates a resource allocation, or one or more directional beams, or both, used by the first base station and the second base station for periodic transmissions to one or more other devices, wherein the resource allocation, or the one or more directional beams, or both, are configured to mitigate CLI at the first base station based at least in part on the signaling.

Aspect 14: The method of aspect 13, wherein the signaling comprises an indication of one or more patterns corresponding to the periodic transmissions, and wherein mitigation of the CLI is based at least in part on the one or more patterns.

Aspect 15: The method of any of aspects 1 through 14, wherein measuring the first set of reference signals comprises: measuring respective reference signals received in each subband of a set of subbands to obtain the CLI channel measurements.

Aspect 16: The method of aspect 15, wherein the set of subbands are configured for full-duplex communications.

Aspect 17: The method of any of aspects 1 through 16, wherein the one or more CLI mitigation procedures comprise beamforming nulling, combiner modification, interference cancellation, or any combination thereof.

Aspect 18: The method of any of aspects 1 through 17, wherein the first set of reference signals comprise one or more types of reference signals, the one or more types of reference signals comprising a CSI-RS, an SSB, a DMRS, or any combination thereof.

Aspect 19: The method of aspect 18, wherein measuring the first set of reference signals comprises: measuring the first set of reference signals using a single-port measurement scheme or a multi-port measurement scheme, or both, based at least in part on the one or more types of reference signals.

Aspect 20: A method for wireless communication at a first base station, comprising: transmitting, to a second base station, a first set of reference signals associated with CLI channel measurements, the second base station being identified based at least in part on a second set of reference signals, wherein the first base station is from a set of one or more aggressor base stations that each transmit downlink signals that interfere with uplink signals at the second base station; receiving, from the second base station, a measurement report comprising an indication of CLI channel measurements that are based at least in part on the first set of reference signals; and performing one or more CLI management procedures based at least in part on the CLI channel measurements.

Aspect 21: The method of aspect 20, further comprising: receiving, from the second base station, one or more reference signals of the second set of reference signals based at least in part on an uplink signal of the first base station being affected by CLI from downlink signals from the first base station; and transmitting, to the second base station, one or more additional reference signals of the second set of reference signals in response to the received one or more reference signals, wherein the measurement report is received based at least in part on one or more additional reference signals transmitted to the second base station satisfying a threshold interference level.

Aspect 22: The method of any of aspects 20 through 21, further comprising: transmitting, to the second base station, one or more reference signals of the second set of reference signals, the one or more reference signals comprising an identifier of the first base station, wherein the measurement report is received based at least in part on the identifier or the first base station and the one or more reference signals transmitted to the second base station satisfying a threshold interference level.

Aspect 23: The method of any of aspects 20 through 22, further comprising: transmitting, to the second base station, a message indicating a configuration of the first set of reference signals, wherein the configuration of the first set of reference signals comprises one or more types of reference signals used for the first set of reference signals, time and frequency resources associated with the first set of reference signals, port information associated with the first set of reference signals, or any combination thereof.

Aspect 24: The method of aspect 23, wherein the message indicating the configuration of the first set of reference signals is received over a backhaul link between the first base station and the second base station.

Aspect 25: The method of any of aspects 20 through 24, wherein the indication of the CLI channel measurements comprises one or more channel statistics, one or more CLI metrics, an RSSI, an RSRP, or any combination thereof.

Aspect 26: The method of any of aspects 20 through 25, further comprising: communicating signaling with the second base station that indicates a resource allocation, or one or more directional beams, or both, used by the first base station and the second base station for periodic transmissions to one or more other devices, wherein the resource allocation, or the one or more directional beams, or both, are configured to mitigate CLI at the first base station based at least in part on the signaling.

Aspect 27: The method of any of aspects 20 through 26, wherein the measurement report is received over a backhaul link between the first base station and the second base station.

Aspect 28: The method of any of aspects 20 through 27, wherein the one or more CLI management procedures comprise beamforming modification, precoder modification, directional beam restriction, or any combination thereof.

Aspect 29: An apparatus for wireless communication at a first base station, comprising a memory; and a processor coupled to the memory and configured to cause the apparatus to perform a method of any of aspects 1 through 19.

Aspect 30: An apparatus for wireless communication at a first base station, comprising at least one means for performing a method of any of aspects 1 through 19.

Aspect 31: A non-transitory computer-readable medium storing code for wireless communication at a first base station, the code comprising instructions executable by a processor to perform a method of any of aspects 1 through 19.

Aspect 32: An apparatus for wireless communication at a first base station, comprising a memory; and a processor coupled to the memory and configured to cause the apparatus to perform a method of any of aspects 20 through 28.

Aspect 33: An apparatus for wireless communication at a first base station, comprising at least one means for performing a method of any of aspects 20 through 28.

Aspect 34: A non-transitory computer-readable medium storing code for wireless communication at a first base station, the code comprising instructions executable by a processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first base station, comprising:
a memory; and
a processor coupled to the memory and configured to:
receive, from a second base station from a set of one or more aggressor base stations, a first set of reference signals associated with cross-link interference channel measurements, the second base station being identified based at least in part on receiving a second set of reference signals from each aggressor base station from the set of one or more aggressor base stations, wherein each aggressor base station from the set of one or more aggressor base stations transmits downlink signals that interfere with uplink signals at the first base station;
measure the first set of reference signals to obtain the cross-link interference channel measurements; and
perform one or more cross-link interference mitigation procedures based at least in part on the cross-link interference channel measurements.

2. The apparatus of claim 1, wherein the processor is further configured to:
transmit, to each aggressor base station from the set of one or more aggressor base stations, one or more reference signals of the second set of reference signals based at least in part on an uplink signal of the first base station being affected by cross-link interference; and
receive, from each aggressor base station from the set of one or more aggressor base stations, one or more additional reference signals of the second set of reference signals in response to the transmitted one or more reference signals, wherein the second base station is identified based at least in part on one or more additional reference signals received from the second base station satisfying a threshold interference level.

3. The apparatus of claim 1, wherein the processor is further configured to:
receive one or more reference signals of the second set of reference signals from the second base station, the one or more reference signals comprising an identifier of the second base station, wherein the second base station is identified based at least in part on the identifier or the second base station and the one or more reference signals from the second base station satisfying a threshold interference level.

4. The apparatus of claim 1, wherein the processor is further configured to:
determine one or more beam directions used by the second base station for transmitting the downlink signals based at least in part on a quasi co-location relationship between the first set of reference signals and the second set of reference signals, wherein the one or more cross-link interference mitigation procedures are based at least in part on the one or more beam directions.

5. The apparatus of claim 1, wherein the processor is further configured to:
receive, from the second base station, a message indicating a configuration of the first set of reference signals, wherein the configuration of the first set of reference signals comprises one or more types of reference signals used for the first set of reference signals, time and frequency resources associated with the first set of reference signals, port information associated with the first set of reference signals, or any combination thereof.

6. The apparatus of claim 5, wherein the message indicating the configuration of the first set of reference signals is received over a backhaul link between the first base station and the second base station.

7. The apparatus of claim 1, wherein the processor is further configured to:
transmit, to the second base station, a measurement report comprising an indication of the cross-link interference channel measurements.

8. The apparatus of claim 7, wherein indication of the cross-link interference channel measurements comprises an explicit indication of the cross-link interference channel measurements, the explicit indication being compressed or uncompressed.

9. The apparatus of claim 7, wherein the indication of the cross-link interference channel measurements comprises one or more channel statistics, one or more cross-link interference metrics, a received signal strength indicator, a reference signal received power, or any combination thereof.

10. The apparatus of claim 7, wherein the measurement report is transmitted over a backhaul link between the first base station and the second base station.

11. The apparatus of claim 1, wherein the processor configured to measure the first set of reference signals is further configured to:
select one or more combiner matrices based at least in part on a combiner codebook that comprises a set of two or more combiner matrices;
measure, in a first subband, one or more reference signals of the first set of reference signals using the one or more combiner matrices; and
measure, in a second subband, one or more additional reference signals of the first set of reference signals using the one or more combiner matrices.

12. The apparatus of claim 11, wherein the processor is further configured to:
select, for each of the first subband and the second subband, a respective combiner matrix from the one or more combiner matrices that is associated with a threshold level of cross-link interference based at least in part on measuring the one or more reference signals and the one or more additional reference signals.

13. The apparatus of claim 1, wherein the processor is further configured to:
communicate signaling with the second base station that indicates a resource allocation, or one or more directional beams, or both, used by the first base station and the second base station for periodic transmissions to one or more other devices, wherein the resource allocation, or the one or more directional beams, or both, are configured to mitigate cross-link interference at the first base station based at least in part on the signaling.

14. The apparatus of claim 13, wherein the signaling comprises an indication of one or more patterns corresponding to the periodic transmissions, and wherein mitigation of the cross-link interference is based at least in part on the one or more patterns.

15. The apparatus of claim 1, wherein the processor configured to measure the first set of reference signals is further configured to:
measure respective reference signals received in each subband of a set of subbands to obtain the cross-link interference channel measurements.

16. The apparatus of claim 15, wherein:
the set of subbands are configured for full-duplex communications.

17. The apparatus of claim 1, wherein the one or more cross-link interference mitigation procedures comprise beamforming nulling, combiner modification, interference cancellation, or any combination thereof.

18. The apparatus of claim 1, wherein the first set of reference signals comprises one or more types of reference signals, the one or more types of reference signals comprising a channel state information reference signal, a synchronization signal block, a demodulation reference signal, or any combination thereof.

19. The apparatus of claim 18, wherein the processor configured to measure the first set of reference signals is further configured to:
measure the first set of reference signals using a single-port measurement scheme or a multi-port measurement scheme, or both, based at least in part on the one or more types of reference signals.

20. An apparatus for wireless communication at a first base station, comprising:
a memory; and
a processor coupled to the memory and configured to:
transmit, to a second base station, a first set of reference signals associated with cross-link interference channel measurements, the second base station being identified based at least in part on a second set of reference signals, wherein the first base station is from a set of one or more aggressor base stations that each transmit downlink signals that interfere with uplink signals at the second base station;
receive, from the second base station, a measurement report comprising an indication of cross-link interference channel measurements that are based at least in part on the first set of reference signals; and
perform one or more cross-link interference management procedures based at least in part on the cross-link interference channel measurements.

21. The apparatus of claim 20, wherein the processor is further configured to:
receive, from the second base station, one or more reference signals of the second set of reference signals based at least in part on an uplink signal of the first base station being affected by cross-link interference from downlink signals from the first base station; and
transmit, to the second base station, one or more additional reference signals of the second set of reference signals in response to the received one or more reference signals, wherein the measurement report is received based at least in part on one or more additional reference signals transmitted to the second base station satisfying a threshold interference level.

22. The apparatus of claim 20, wherein the processor is further configured to:
transmit, to the second base station, one or more reference signals of the second set of reference signals, the one or more reference signals comprising an identifier of the first base station, wherein the measurement report is received based at least in part on the identifier or the first base station and the one or more reference signals transmitted to the second base station satisfying a threshold interference level.

23. The apparatus of claim 20, wherein the processor is further configured to:
transmit, to the second base station, a message indicating a configuration of the first set of reference signals, wherein the configuration of the first set of reference signals comprises one or more types of reference signals used for the first set of reference signals, time and frequency resources associated with the first set of reference signals, port information associated with the first set of reference signals, or any combination thereof.

24. The apparatus of claim 23, wherein the message indicating the configuration of the first set of reference signals is received over a backhaul link between the first base station and the second base station.

25. The apparatus of claim 20, wherein the indication of the cross-link interference channel measurements comprises one or more channel statistics, one or more cross-link interference metrics, a received signal strength indicator, a reference signal received power, or any combination thereof.

26. The apparatus of claim 20, wherein the processor is further configured to:
communicate signaling with the second base station that indicates a resource allocation, or one or more directional beams, or both, used by the first base station and the second base station for periodic transmissions to one or more other devices, wherein the resource allocation, or the one or more directional beams, or both, are configured to mitigate cross-link interference at the first base station based at least in part on the signaling.

27. The apparatus of claim 20, wherein the measurement report is received over a backhaul link between the first base station and the second base station.

28. The apparatus of claim 20, wherein the one or more cross-link interference management procedures comprise beamforming modification, precoder modification, directional beam restriction, or any combination thereof.

29. A method for wireless communication at a first base station, comprising:
receiving, from a second base station from a set of one or more aggressor base stations, a first set of reference signals associated with cross-link interference channel measurements, the second base station being identified based at least in part on receiving a second set of reference signals from each aggressor base station from the set of one or more aggressor base stations, wherein each aggressor base station from the set of one or more aggressor base stations transmits downlink signals that interfere with uplink signals at the first base station;
measuring the first set of reference signals to obtain the cross-link interference channel measurements; and
performing one or more cross-link interference mitigation procedures based at least in part on the cross-link interference channel measurements.

30. A method for wireless communication at a first base station, comprising:
transmitting, to a second base station, a first set of reference signals associated with cross-link interference channel measurements, the second base station being identified based at least in part on a second set of reference signals, wherein the first base station is from a set of one or more aggressor base stations that each transmit downlink signals that interfere with uplink signals at the second base station;
receiving, from the second base station, a measurement report comprising an indication of cross-link interference channel measurements that are based at least in part on the first set of reference signals; and
performing one or more cross-link interference management procedures based at least in part on the cross-link interference channel measurements.
